(19) United States
(12) Patent Application Publication
(10) Pub. No.: US 2004/0159241 A1
(43) Pub. Date: Aug. 19, 2004

(54) Alcoholic beverage device

(76) Inventor: Bradley Lee Bailey, Orlando, FL (US)

Correspondence Address: Bradley Lee Bailey, 10771 Spring Brook Ln., Orlando, FL, 32825, US

(21) Appl. No.: 10/368,104

(22) Filed: Feb. 18, 2003

(51) Int. Cl. A23L 1/00

(52) U.S. Cl. 99/275

(57) ABSTRACT

An alcoholic beverage (12) contained within an outer shell (10). This Alcoholic Beverage Device is a single product with multiple characteristic possibilities. The device can specifically be used for the unique purpose of containing individual serving quantities of a gelatinous-alcoholic beverage. The outer shell may be edible or non-edible. The device may also contain a dissolvable outer shell and, when placed in beverages, release alcohol as it dissolves. This device can also contain shots, mixed shooters, and other variations of individually consumable liquid alcoholic beverages. This device can further be refrigerated, and used to cool beverages.

### CROSS-REFERENCE TO RELATED APPLICATIONS

Not Applicable

### FEDERALLY SPONSORED RESEARCH

Not Applicable

### SEQUENCE LISTING OF PROGRAM

Not Applicable

### BACKGROUND OF THE INVENTION—FIELD OF INVENTION

This invention relates to an Alcoholic Beverage Device for the purpose of alcoholic beverage consumption, and marketing. This invention specifically relates to a product capable of containing gelatinous-alcoholic beverages for individual serving quantities. This invention further relates to a product capable of dissolving, and introducing alcohol into a beverage as it dissolves. This invention further relates to a product capable of being refrigerated for the purpose of being placed in, and cooling beverages.

### BACKGROUND OF THE INVENTION

Alcoholic beverages are a well-known product. They are consumed for the purpose of taste and/or their pleasant inebriating effects. Individuals partaking in alcoholic beverages are often attempting to enhance social events, and create a fun atmosphere. However, until now, alcoholic beverages have come with several limitations.

Alcohol producers have failed to create a convenient and marketable product for alcohol consumers who desire the inebriating effects of alcoholic beverages, but who do not desire the taste. A product containing individual serving quantities of a gelatinous-alcoholic beverage is ideal for this large consumer group, but until now, has gone unrecognized.

Alcohol consumers are further limited to the production of alcohol in a liquid form. This requires awkward measuring methods that are often unreliable, time-consuming, costly, and susceptible to human errors when preparing beverages. Consumers become unaware of the exact alcohol content of their beverage. This often results in the consumption of an unknown amount of alcohol, and a lack of control in the inebriating effects that result.

Alcohol producers have also lacked innovation in their products. Alcohol can typically only be purchased in bottles, or other standard containers. This results in alcohol being purchased in bulk, and not for individual serving quantities. For example, a coffee drinker must purchase an entire bottle of Kalhua, Amaretto, Irish Crème, Galliano, and Grand Marnier, if they desire to have a variety of coffee liqueurs. No product currently exists that can be easily combined into variety packs of individual serving quantities.

Furthermore, alcohol consumers frequently attempt to cool an alcoholic beverage with ice composed of water. If not consumed immediately, this ice will melt, and dilute the taste of the alcoholic beverage. This produces an undesirable effect.

### BACKGROUND OF THE INVENTION—OBJECTS AND ADVANTAGES

Several objects and advantages of the present invention are:

(a) to provide a product for containing, and consuming individual serving quantities of alcoholic beverages in a gelatinous, or other solidified form;

(b) to provide a single alcoholic beverage product with multiple possible characteristics;

(c) to provide a product capable of being produced in a variety of shapes, designs, sizes, colors, flavors, and variety packs for the purpose of satisfying individual consumer groups;

(d) to provide a product capable of dissolving, and enhancing the flavor, and alcoholic content of a beverage as it dissolves;

(e) to provide a product that eliminates, or compliments the taste of alcoholic beverages when consumed individually;

(f) to provide a product with unique, fun, and novel features capable of enhancing social events;

(g) to provide a product that eliminates the need for time consuming, costly, and unreliable measurement methods when serving alcoholic beverages;

(h) to provide a product capable of being refrigerated, and cooling alcoholic beverages without a diluting effect.

### BRIEF EXPLANATION OF THE DRAWINGS

FIG. 1 is a diagram showing a sample Alcoholic Beverage Device.

FIG. 2 is a diagram showing a sample alternatively shaped Alcoholic Beverage Device.

FIG. 3 is a diagram showing a sample alternatively shaped Alcoholic Beverage Device.

FIG. 4 is a diagram showing a sample alternatively shaped Alcoholic Beverage Device.

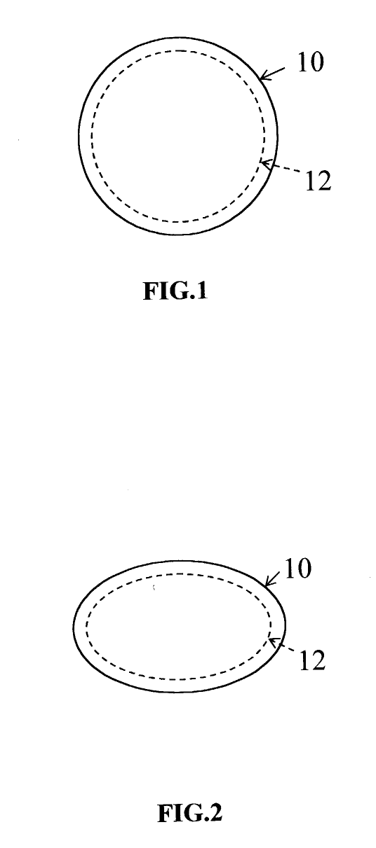

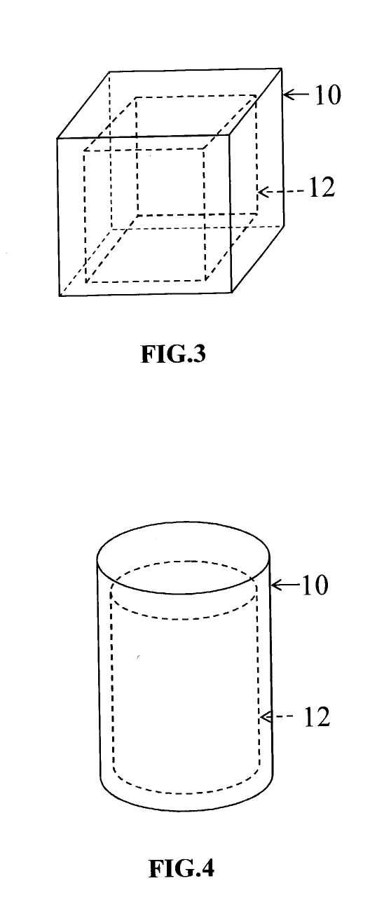

Drawings-Reference Numerals

10. outer shell 12. alcoholic beverage

### SUMMARY OF THE INVENTION

The Alcoholic Beverage Device is a single alcoholic beverage product with multiple possible characteristics. The device is an alcoholic beverage contained within a unique outer shell. The device is specifically used to contain individual serving quantities of gelatinous-alcoholic beverages, but may be used for several purposes. The outer shell may be tasty and edible, or non-edible. Each outer shell is designed to complement specific alcohol flavors, and consumption purposes. The device can be placed in drinks, and releases alcohol as it dissolves. The device can further be used for shots, mixed shooters, and other variations of individually consumable gelatinized alcoholic beverages. The device can be refrigerated, and used to cool beverages without a diluting effect. The Alcoholic Beverage Device is a fun concept that incorporates a highly marketable product with practical applications desired of many alcohol consumers.

### DETAILED DESCRIPTION OF INVENTION

The Alcoholic Beverage Device is specifically a product containing individual serving quantities of gelatinous-alcoholic beverages. A product for containing individual serving quantities of popular gelatinous-alcoholic beverages has not been created, and is an extremely unique feature of this product. However, this device has several possible characteristic variations, and many useful purposes. The Alcoholic Beverage Device contains two major components. The first component is the outer shell. The later component is the inner alcoholic beverage.

The outer shell may be produced from a variety of products for the purposes of texture, strength, color, flavor, and overall appearance. The outer shell is ideally composed of dissolvable and/or edible ingredients, but non-edible ingredients may also be included. The outer shell can be created from any well-known ingredients. One ideal example is a crystallized hard candy substance, or any other popular candy variations. The outer shell may also be created from any dissolvable ingredients. One example of a dissolvable outer shell may contain a dissolvable-gelatin product as the primary ingredient. Gelatin is a well-known protein that is obtained especially from the collagen-containing parts of animals, such as skin, bone, and ossein. Gelatin is produced from this collagen-containing material by decomposition, usually by either acid hydrolysis or alkaline hydrolysis, and different types of gelatin can be prepared by changing the process parameters. The amount of gelatin used depends on the desired degree of gelatinization of the jellying product; the harder the gel is to be, the more gelatin is needed. This outer shell may be combined with any known ingredients for the purpose of enhancing the flavor, color, texture, and overall consistency. This outer shell may be produced in a variety of shapes and sizes using any number of conventional injection, and other well-known molding techniques. Several ideal shapes for the outer shell include a sphere, square, cylinder, and other geometric variations. However, any ideal shape, or design may be used.

The outer shell may ideally be composed of dissolvable and/or jellying ingredients when serving the alternate purpose of containing a liquid alcoholic beverage. No product currently exists that contains a liquid alcoholic beverage within a dissolvable outer shell. Also, no product currently exists that contains alcohol within a gelatinous outer shell. These are both desirable characteristics, and alternate purposes of the Alcoholic Beverage Device.

The inner portion of the device is ideally a gelatinous-alcoholic beverage. The alcoholic beverage may be gelatinized, or solidified using previously mentioned gelatinization processes, or any well-known gelatinization, and solidification processes. This beverage may be injected into the outer shell, manufactured within the outer shell, or any other number of ideal methods of production. The gelatinous-alcoholic beverage may also be split into multiple segments of sufficient size to be swallowed whole. The beverage may contain any single or multiple alcoholic, and non-alcoholic beverages. Ideal gelatinous-alcoholic beverages may include Kalhua, Amaretto, Irish Crème, Galliano, Grand Marnier, Whiskey, Rum, Tequila, Vodka, Gin, Brandy, Curacao, Yager Meister, and any desirable Liqueurs. Ideal gelatinous-alcoholic mixed drinks and shooters may include a Mudslide, White Russian, B-52, Lemon Drop, Kamikaze, Melon Ball, Screwdriver, Grasshopper, Margarita, and other popular mixed drinks.

The Alcoholic Beverage Device is intended to be used for several purposes. The outer shell may be edible, and for the purpose of containing individual serving quantities of edible gelatinous-alcoholic beverages. The outer shell may be also be non-edible, and for the purpose of containing individual servings of gelatinous-alcoholic beverages. The invention may ideally be dissolvable, and dispense alcohol into a beverage as it dissolves. The invention may also be easily chewable and/or easily swallowed for consumption of individual alcoholic beverages. The device may also be refrigerated, and used to cool beverages while adding alcoholic contents and flavor to the beverage.

The Alcoholic Beverage Device may specifically contain a non-edible outer shell for the purpose of containing the edible gelatinous alcoholic beverage. If a non-edible outer shell is desired, the outer shell will ideally contain any known non-edible ingredients such as plastics. However, edible ingredients may also be included. These ingredients are molded into a geometric, or other desirable shape using any well-known molding techniques such as injection molding. The gelatinous-alcoholic beverage may be injected into the outer shell, manufactured within the outer shell, or any other number of ideal methods of production. The outer shell may be broken, peeled, or opened for the purpose of consuming the inner gelatinous-alcoholic beverage. One example would be an alcoholic product similar to a hard boiled egg, wherein the outer shell may be discarded, and the inner gelatinized alcoholic beverage may be consumed. Another example would be a hollow plastic egg filled with the gelatinized alcoholic beverage, wherein the outer shell is capable of being opened, and the inner gelatinous-alcoholic beverage may be consumed.

This device may also specifically contain an edible outer shell for the purpose of containing the edible gelatinous-alcoholic beverage. An example would be the outer shell composed of an edible candy, and the inner gelatinous-alcoholic beverage for the purpose of consumption. Another example would be a chocolate outer shell filled with the gelatinous-alcoholic beverage. These products can be manufactured using previously discussed methods of production, or any known desirable methods.

### EXAMPLE

Preparation of the Alcoholic Beverage Device According to the Invention

The following raw materials were used

| | |
|---|---|
| Fruit Juice | 3 ¾ cups |
| Hollow Plastic Easter Eggs | 2 ½ inches by 1 ¾ inches |
| Unflavored Gelatin | 1/5 cups |
| Vodka | 1/4 cups |

3 cups of fruit juice were poured into a pot, and heated on an open stove until boiling occurred. ¾ cup of cold Fruit Juice was mixed with ¼ cup of Vodka in a bowl. ⅕ cup of unflavored gelatin was poured over the Vodka and cold Fruit Juice in the bowl. After 1 minute, the 3 cups of the boiling Fruit Juice were poured into the bowl, and mixed until the gelatin dissolved. After 5 minutes, the contents of the bowl were injected into hollow plastic eggs through an approximately 4/16 inch opening, and placed in a refrigerator. Each egg was wrapped with tape around all openings to prevent leaking, and ¼ cup of the mixture was injected into each egg. After approximately 3 hours, each egg contained an edible, and tasty gelatinous-alcoholic beverage.

What is claimed is:

1. An alcoholic beverage device comprising:
(a) an outer shell, and
(b) a gelatinous-alcoholic beverage contained within said outer shell
whereby said alcoholic beverage containing device will provide a unique method of consuming gelatinous-alcoholic beverages in individual serving quantities.

2. An alcoholic beverage device comprising:
(a) a substantially dry-dissolvable outer shell, and
(b) an alcoholic beverage contained within said outer shell
whereby said alcoholic beverage containing device will provide a method of introducing alcohol into beverages as it dissolves, and consuming alcoholic beverages in individual serving quantities.

3. An Alcoholic Beverage Device comprising:
(a) a substantially gelatinous outer shell, and
(b) an alcoholic beverage contained within said outer shell
whereby said alcoholic beverage containing device will provide a method of introducing alcohol into beverages as it dissolves, and consuming alcoholic beverages in individual serving quantities.

4. The device of claim 1 wherein said outer shell is broken for the purpose of consuming said gelatinous-alcoholic beverage.

5. The device alcoholic of claim 1 wherein said outer shell is peeled for the purpose of consuming said gelatinous-alcoholic beverage.

6. The device of claim 1 wherein said outer shell is opened for the purpose of consuming said gelatinous-alcoholic beverage.

7. The device of claim 1 wherein said outer shell contains any non-edible ingredients such as plastic.

8. The device of claim 1 wherein said outer shell contains edible ingredients such as any well-known candy substance.

9. The device of claim 1 wherein said outer shell contains chocolate as a primary ingredient.

10. The device of claim 1 wherein said outer shell contains a jellying agent.

11. The device of claim 1 wherein the device is a size sufficiently capable of being swallowed.

12. The device of claim 1 wherein the device is a consistency capable of being chewed.

13. The device of claim 2 wherein said outer shell contains a jellying agent.

14. The device of claim 2 wherein said alcoholic beverage contains a jellying agent.

15. The device of claim 2 wherein said alcoholic beverage is solidified using any known alcohol solidification process.

16. The device of claim 2 wherein the device is a size sufficiently capable of being swallowed.

17. The device of claim 3 wherein said outer shell contains a jellying agent.

18. The device of claim 3 wherein said alcoholic beverage contains a jellying agent.

19. The device of claim 3 wherein said alcoholic beverage is solidified using any known solidification process.

20. The device of claim 3 wherein the device is a size sufficiently capable of being swallowed.
